(19) United States
(12) Patent Application Publication
(10) Pub. No.: US 2004/0042598 A1
(43) Pub. Date: Mar. 4, 2004

(54) Method for indicating a call reaching a communication terminal

(76) Inventors: Gero Offer, Stuttgart (DE); Hildegard Wiggenhorn, Munchen (DE)

Correspondence Address: MORRISON & FOERSTER LLP, 1650 TYSONS BOULEVARD, SUITE 300, MCLEAN, VA, 22102, US

(21) Appl. No.: 10/275,684

(22) PCT Filed: May 10, 2001
(86) PCT No.: PCT/DE01/01810

(30) Foreign Application Priority Data
May 10, 2000 (DE) 100-23-474.3

(51) Int. Cl. H04M 1/56; H04M 15/06; H04M 3/42

(52) U.S. Cl. 379/142.01; 379/142.05; 379/210.03

(57) ABSTRACT

The invention relates to a method for signaling the call of a call-communication device (1) reaching a communication terminal (2). The aim of the invention is to enlarge the possibilities of allocating identifications to such calls. To this end, at least one identification signal (S7,S7′) describing an identification is transmitted to the communication terminal (2) by the call-communication device (1) when the call is sent and the communication terminal (2) outputs the corresponding identification

### CLAIM FOR PRIORITY

This application is a national stage of PCT/DE01/01810 filed May 10, 2001, which is based on German application 100 23 474.7 filed May 10, 2000.

### TECHNICAL FIELD OF THE INVENTION

The invention relates to a method for indicating a call from a call communication device reaching a communication terminal.

### BACKGROUND OF THE INVENTION

Conventional telecommunications technology disclose a call reaching a communication terminal constructed as a telephone is indicated by this communication terminal outputting ringing sounds.

It is also known from the Internet page with the title “Nokia 3210”, with the Internet address http://www.nokia.de/mobile phones/produkte/3210/, that on a communication terminal suitable for receiving calls, callers can be allocated different ringing sounds as identifiers at the communication terminal so that the callers can already be recognized from the individual ringing sound.

### SUMMARY OF THE INVENTION

The invention specifies a method by means of which the possibilities of allocating identifiers to calls reaching the communication terminal can be extended.

According to one embodiment of the invention, there is a method in that, when the call is sent out by the call communication device, at least one identification signal describing an identifier is transmitted to the communication terminal and the communication terminal, in response to the identification signal, outputs the identifier in the form of at least one audible sound. This also includes outputting entire melodies as a sequence of audible sounds. This method has one advantage in that the call communication device can specify the identifier which is output to the communication terminal for indicating the call of precisely this call communication device. The method according to the invention is not restricted to use for a traditional telephone or mobile telephone but can also be used, e.g. when telephoning by means of PC via the Internet (e.g. via the so-called VoIP (Voice over Internet Protocol) method) or in the so-called WAP (Wireless Application Protocol) push method or the SMS (Short Message Service) push method.

In another embodiment according to the invention, an identifier allocated to the identification signal can be output as identifier by the communication terminal. It is advantageous then that the identification signal to be transmitted only needs to contain an identification (that is to say e.g. a name or a designation) of the identifier. The identifier described by means of this identification signal can then be output at the communication terminal on the basis of this identification. The identifier can be allocated to the identification signal in the communication terminal or also in an allocation device interposed between the call communication device and the communication terminal (e.g. a server of a communication network connecting the call communication device and the communication terminal).

In still another embodiment according to the invention, the invention is designed in such a manner that the identifier is transmitted with the identification signal and this identifier is output by the communication terminal. The complete identifier is then transmitted in a suitable form together with the identification signal to the communication terminal and output by the latter. This has the advantage, that identifiers existing in the call communication device before the call is set up can also be output at the communication terminal.

An advantageous embodiment according to the invention provides that the identifier to be transmitted with the identification signal is read out of a memory of the call communication device. It is then particularly advantageous that different identifiers can be kept stored in the memory of the call communication device and a suitable identifier can be read out when a call is set up.

In a further embodiment according to the invention, the identifier can be output via an output device of the communication terminal. If a suitable output device is selected, the most varied identifiers can be output by the communication terminal.

In still another embodiment according to the invention, before the identification signal is transmitted, a check is made as to whether the call communication device has an authorization for transmitting the identification signal and, if the authorization exists, the identification signal is transmitted. It is then advantageous that the identification signal is transmitted if the call communication device has an authorization for transmitting the identification signal and that no identification signal can be transmitted by unauthorized call communication devices.

In another embodiment according to the invention, the invention is designed in such a manner that, in order to check the authorization of the call communication terminal, it is determined whether the latter belongs to a list of authorized call communication devices allocated to the communication terminal. In this context, an authorization for transmitting identification signals to the communication terminal can be issued to a call communication device in a simple manner by including the call communication device in the list allocated to the communication terminal.

### BRIEF DESCRIPTION OF THE DRAWINGS

To provide a further explanation according to the invention,

FIG. 1 shows an exemplary embodiment of a call communication device and a communication terminal.

FIG. 2 shows an exemplary embodiment of the invention.

### DETAILED DESCRIPTION OF THE INVENTION

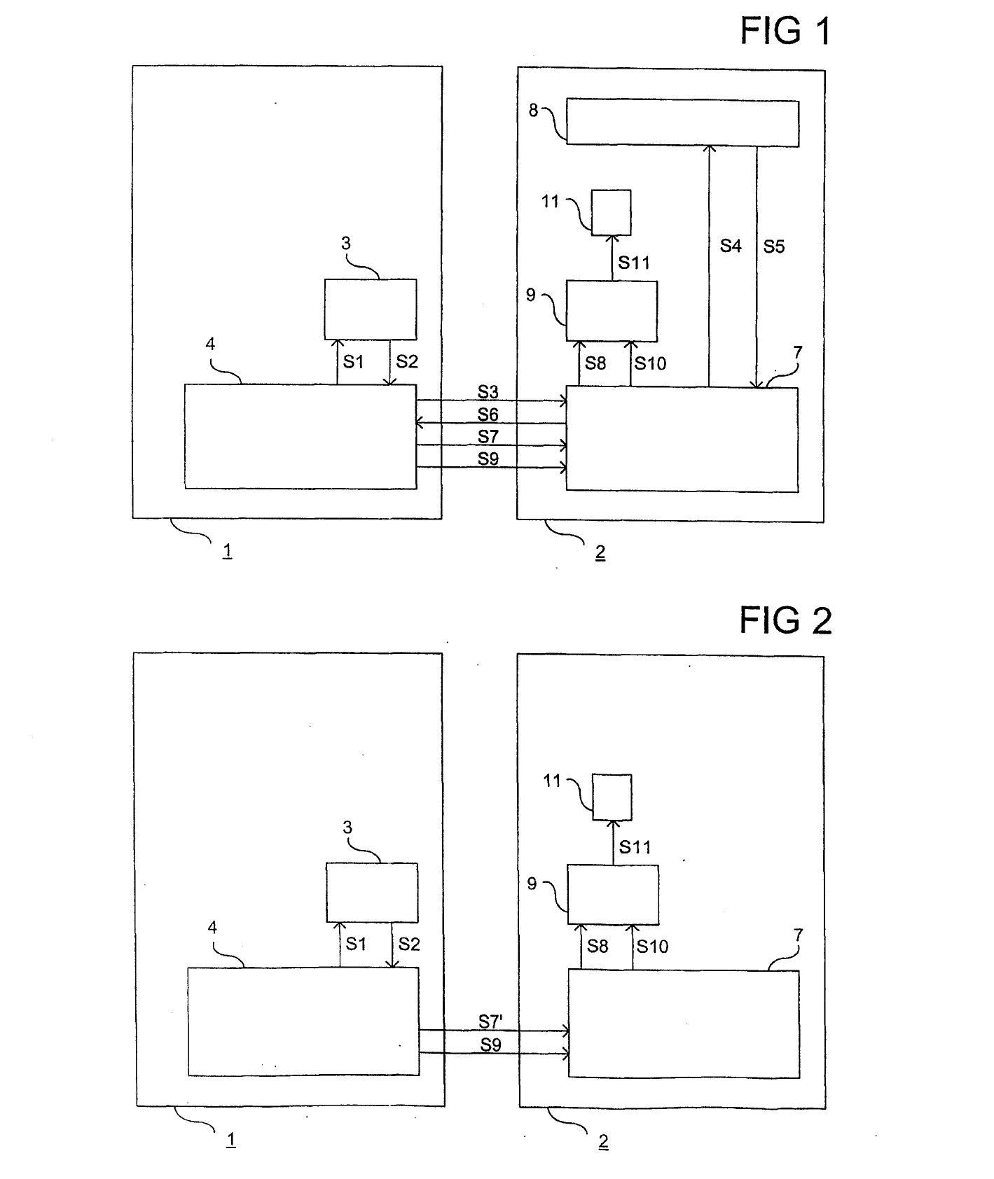

FIG. 1 shows on the left-hand side a call communication device 1 which is to call a communication terminal 2 shown on the right-hand side. For this purpose, at least one identifier is stored in a memory 3 of the call communication device 1. In the memory 3, for example audible sounds or melodies in the form of sequences of such audible sounds can be stored as identifier and, in addition, it is possible to store colors, pictures or animations or video clips in the form of picture sequences as identifiers.

A connection module 4 at the call communication terminal end addresses the memory 3 with a signal S1 and requests one of the stored identifier. This memory 3 thereupon sends the requested identifier to the connection module 4 at the call communication terminal end by means of a signal S2. The connection module 4 at the call communication terminal end thereupon sets up a data link with a connection module 7 of the communication terminal 2 at the communication terminal end. Via this data link, a signal S3 is sent which informs the communication terminal 2 that the call communication device 1 wishes to send an identification signal with the requested identifier to the communication terminal 2. The connection module 7 at the communication terminal end thereupon enquires at a list memory 8, in which a list, allocated to the communication terminal 2, of call communication devices authorized for transmitting identification signals exists, by means of an enquiry signal S4 whether the call communication device 1 is present in this list. The list memory 8 sends this information about the presence or absence back to the connection module 7 at the communication terminal end with a reply signal S5.

For the exemplary embodiment, the call communication device 1 belongs to the list stored in the list memory 8 so that the reply signal S5 transmits its presence; thus there is authorization for transmitting the identification signal. The connection module 7 at the communication terminal end, therefore, sends a signal S6 to the connection module 4 at the call communication terminal end and requests the latter to transmit the identification signal with the identifier. The connection module 4 at the call communication terminal end thereupon transmits the identifier by means of an identification signal S7 to the connection module 7 at the communication terminal end, which then stores the identifier of the identification signal S7 with a signal S8 in a destination memory 9 of the communication terminal 2. After the identifier has been received by the connection module 7 at the communication terminal end, a reception acknowledgement signal can be additionally sent by the connection module 7 at the communication terminal end to the connection module 4 at the call communication terminal end; however, this is not shown in FIG. 1.

The call communication device 1 then sends a signal S9 to the communication terminal 2; the signal S9 initiates the setting up of a voice link between the two terminals. After the signal S9 has arrived, the connection module 7 at the communication terminal end sends a signal S10 to the destination memory 9 and by this means instructs the latter to transmit the previously stored identifier to an output device 11 of the communication terminal 2 by means of a signal S11. This output device 11 outputs the identifier; as a result, the call reaching the communication terminal 2 is indicated.

The destination memory 9 and the output device 11 are suitable for storing and outputting, respectively, different types of identifier. Thus, for example, audible sounds or melodies in the form of sound sequences can be stored in the destination memory 9. To output these sounds, the output device 11 includes, e.g. a loudspeaker. Similarly, pictures or animations or video clips in the form of picture sequences can be stored in the destination memory 9. To output this type of identifier, the output device contains, e.g. an LCD display.

To set up the above-mentioned data link between the call communication device 1 and the communication terminal 2, a D channel of an ISDN (Integrated Services Digital Network) communication network can be used, for example. Similarly, the data link can be implemented as a packet-oriented link via a data channel of a GPRS (General Packet Radio Services) communication network; in this case, a voice channel of the GPRS communication network can be reserved or set up virtually simultaneously. As a third exemplary possibility, the data link can be set up as a packet-oriented link via a UMTS (Universal Mobile Telecommunication System) communication network; the voice link between the terminals can then be implemented, e.g. by means of VoIP (Voice over Internet Protocol) technology.

FIG. 2 shows the invention in conjunction with FIG. 1, and is simplified if during the transmission of the identification signal S7 with the identifier, and the checking of the authorization of the call communication device 1 is omitted. For this purpose, the representation from FIG. 1 has been largely retained while keeping the reference symbols. In this case, no list memory is required in the communication terminal 2. Thus, the signals S4 and S5 which are shown in conjunction with the list memory 8 in FIG. 1 are also omitted. Similarly, the signals S3 and S6 shown in FIG. 1 are unnecessary. In deviation from the method explained in conjunction with FIG. 1, the connection module 4 at the call communication terminal end, after receiving the signal S2, immediately transmits the identifier to the connection module 7 at the communication terminal end by means of a modified identification signal S7′. The signals S8 to S11 following it in time are then used as shown above in conjunction with FIG. 1.

Similarly—but not shown in the Figures—the identifier can be output via the output device of the communication terminal immediately after the arrival of the identification signal (e.g. when so-called streaming methods are used) without the identifier being stored in the destination memory.

1. A method for indicating a call from a call communication device (1) reaching a communication terminal (2), in which
when the call is sent out by the call communication device (1), at least one identification signal (S7, S7) describing an identifier is transmitted to the communication terminal (2), and
the communication terminal (2), in response to the identification signal (S7, S7), outputs the identifier in the form of at least one audible sound.

2. The method as claimed in claim 1, characterized in that
the communication terminal (2) outputs as identifier an identifier allocated to the identification signal (S7, S7).

3. The method as claimed in claim 1, characterized in that
the identifier is transmitted with the identification signal (S7, S7), and
this identifier is output by the communication terminal (2).

4. The method as claimed in claim 3, characterized in that
the identifier to be transmitted with the identification signal (S7, S7) is read out of a memory (3) of the call communication device (1).

5. The method as claimed in one of claims 1 to 4, characterized in that
the identifier is output via an output device (11) of the communication terminal (2).

6. The method as claimed in one of the preceding claims, characterized in that
before the identification signal (S7) is transmitted, a check is made as to whether the call communication device (1) has an authorization for transmitting the identification signal (S7), and
if the authorization exists, the identification signal (S7) is transmitted.

7. The method as claimed in claim 6, characterized in that,
in order to check the authorization of the call communication terminal (1), it is determined whether the latter belongs to a list of authorized call communication devices, allocated to the communication terminal (2).
